(19) United States
(12) Patent Application Publication
(10) Pub. No.: US 2008/0201361 A1
(43) Pub. Date: Aug. 21, 2008

(54) TARGETED INSERTION OF AN AUDIO - VIDEO ADVERTISING INTO A MULTIMEDIA OBJECT

(76) Inventors: Alexander CASTRO, Seattle, WA (US); Jonathan Thompson, Seattle, WA (US)

Correspondence Address: FAY KAPLUN & MARCIN, LLP, 150 BROADWAY, SUITE 702, NEW YORK, NY, 10038, US

(21) Appl. No.: 11/675,893

(22) Filed: Feb. 16, 2007

(51) Int. Cl. G06F 7/00

(52) U.S. Cl. 707/103 R; 707/E17.055

(57) ABSTRACT

A method, system, and computer readable medium for inserting a contextually relevant advertisement object into a multimedia object is presented. The method includes identifying context information from one or more portion of the multimedia object, selecting the advertisement object based on the identified context information, and determining an appropriate position within the portion of the multimedia object to insert the advertisement object.

### BACKGROUND

The present invention generally relates to inserting an advertisement object into a multimedia object, and more particularly, to a method, system, and computer program product for contextually inserting the advertisement object into a multimedia object.

In today's competitive world, businesses are consistently looking for new ways to market their products and services. They generally want as many consumers as possible to view their advertisements. Businesses consider it more likely that a potential customer will view advertisements presented during the customer's viewing of a multimedia object, such as a television show, a movie, or other audio/video (A/V). For example, providing an advertisement object along with a videocast, podcast, or other web-based A/V product is an effective method of presentation. One reason for this is that the potential consumer is most likely interested in viewing the multimedia object, and will willingly continue viewing through the advertisement object in order to view the remainder of the multimedia object.

### SUMMARY

The present invention provides a method for inserting a contextually relevant advertisement object into a multimedia object. The method includes identifying context information from one or more portion of the multimedia object, selecting the advertisement object based on the identified context information, determining an appropriate position within the portion of the multimedia object to insert the advertisement object and inserting the selected advertisement object into the multimedia object at the determined appropriate position.

The present invention further provides system for inserting a contextually relevant advertisement object in a multimedia object. The system includes a context identifier module to identify context information from one or more portions of the multimedia object, an advertisement selection module to select the advertisement object based on the identified context information and a position identifier module to determine an appropriate position within the portion of the multimedia object to insert the advertisement object.

The present invention further provides a computer program product for inserting a contextually relevant advertisement object in a multimedia object. The computer program product includes computer readable program for identifying context information from one or more portion of the multimedia object, computer readable program for selecting the advertisement object based on the identified context information and computer readable program for determining an appropriate position within the portion of the multimedia object to insert the advertisement object.

The present invention further provides a method for inserting an advertisement object into a multimedia object. The method includes processing the multimedia object to identify context information and an appropriate position for insertion of the advertisement object in each of the multimedia object, searching one or more advertisement objects for an advertisement object having a context relevant to the identified context information of the multimedia object, and inserting the advertisement object in the multimedia object at the appropriate position. The method further includes charging an advertiser an additional advertising fee when context of the advertisement object closely matches with the context information.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a system for inserting a contextually relevant advertisement object into multimedia objects issued by plurality of sources, according to an exemplary embodiment of the present invention;

FIG. 2 is a block diagram illustrating a context identifier module, in accordance with an exemplary embodiment of the invention;

FIG. 3 is a block diagram illustrating an advertisement selection module, in accordance with an exemplary embodiment of the invention;

FIG. 4 is a block diagram of an exemplary data processing device suitable for implementing various embodiments of the present invention;

FIG. 5 is a flow diagram representation of a method for inserting a contextually relevant advertisement object in a multimedia object in accordance with an embodiment of the present invention;

FIG. 6 is a flowchart of a method of identifying the context information of the multimedia object, according to an embodiment of the present invention; and

FIG. 7 is a flowchart of selecting the advertisement object, according to an embodiment of the present invention.

### DETAILED DESCRIPTION

In the following description, for purposes of explanation, specific numbers, materials and configurations are set forth in order to provide a thorough understanding of the invention. It will be apparent, however, to one having ordinary skill in the art, that the invention may be practiced without these specific details. In some instances, regular features may be omitted or simplified so as not to obscure the present invention. Furthermore, reference in the specification to “one embodiment” or “an embodiment” means that a particular feature, structure or characteristic described in connection with the embodiment is included in at least one embodiment of the invention. The appearances of the phrase “in an embodiment” in various places in the specification are not necessarily all referring to the same embodiment.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include,” “including,” and “includes” mean including, but not limited to. Also, the terms “advertisement object” and “advertising” are used interchangeably, unless otherwise indicated.

The present invention provides a method, system, and computer program product for inserting a contextually relevant advertisement object in a multimedia object. The multimedia object in the present invention is a media that uses one or more forms of information content and information processing including, without limitation, text, graphics, audio, video, and animation. In various embodiments of the invention, the system identifies context information of a portion of the multimedia object. Further, the system may use the context information to select an advertisement object contextually related to the portion of the multimedia object.

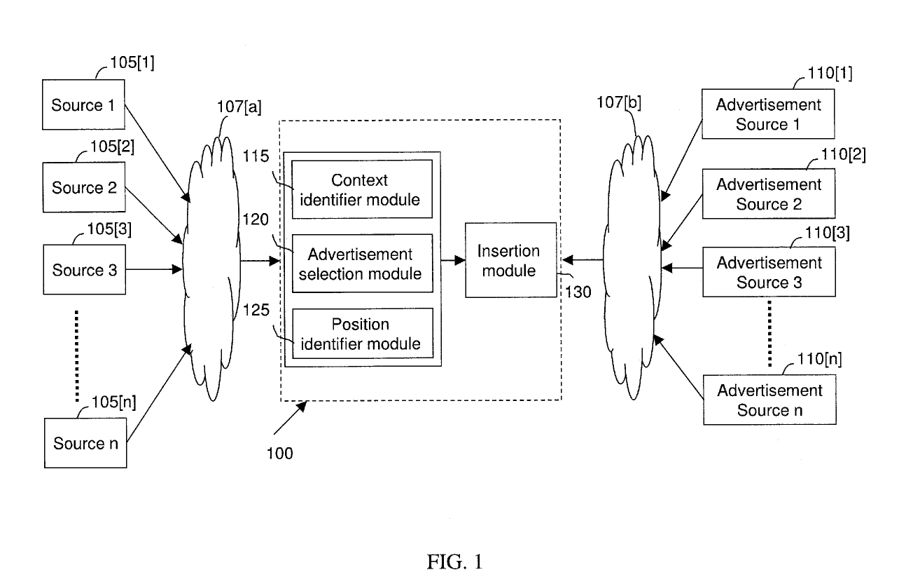

FIG. 1 is a block diagram of an exemplary system 100 for inserting a contextually relevant advertisement object into multimedia objects from any of several multimedia sources 105[1-n]. According to an embodiment of the present invention, the multimedia sources 105 may be a plurality of computers hosting the multimedia objects and are coupled to the system 100 through a network 107[a]. Further, advertisement sources 110[1-n] may also be coupled to the system 100 using a network 107[b]. The advertising sources 110 may also be plurality of computers hosting advertisement objects. The figure shows a number of multimedia sources 105 and a number of advertising sources 110 in order to illustrate embodiments of the present invention with the help of an example, and not to limit the scope of the present invention. In one embodiment of the present invention, the sources 105, and the advertisement sources 110 may be located in distinct geographical locations, such as different counties or regions, and they may be connected to the system 100 via one or several communication links 107a, 107b, such as networks. Examples of network 107 includes, without limitation, Internet, local area network (LAN), Wide Area Network (WAN), and the like.

In another embodiment of the invention, the system 100, multimedia sources 105 and advertisement sources 110 may co-exist within a single network or even on a single data processing device. In such cases, the system 100, multimedia sources 105, and advertisement sources 110 would then be interconnected by appropriate communication links 107a, 107b. For example, if all the components are co-located on a single personal computer device, the communication links 107a, 107b may be an internal data bus, SCSI-II connection, or the like.

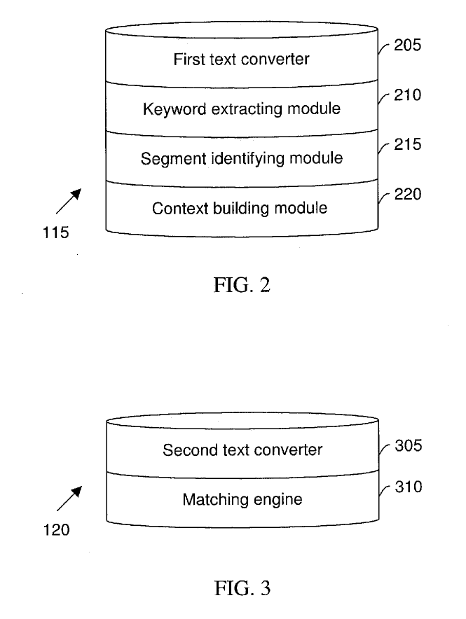

In one embodiment of the invention, the system 100 comprises a context identifier module 115. The context identifier module 115 identifies context information from the multimedia object. In various embodiments of the invention, the context identifier module 115 identifies the context information of one or more portions of the multimedia object. The context identifier module further provides the position of the context information in the multimedia object, hereinafter referred to as the “context position”. The context position is the location of the corresponding context information in the multimedia object. An exemplary embodiment of the context identifier module 115 is described in detail with reference to FIG. 2 below.

Further, the system 100 includes an advertisement selection module 120 to select an advertisement object based on the context information. In various embodiments of the invention, the advertisement selection module 120 does a keywords based search to select the advertisement objects that match the context information. An exemplary embodiment of the advertisement selection module 120 is described in detail with reference to FIG. 3 below.

The system 100 further includes a position identifier module 125 to determine an appropriate position within the portion of the multimedia object to insert the advertisement object. The appropriate position is a location in the multimedia object where the system 100 may insert an advertisement object, and it can be determined in relation to the portion of the multimedia object of the corresponding context information. Alternatively, the appropriate position may be determined relative to the context position of the context information in the multimedia object. For example, an appropriate position for an advertisement related to sport shoe in a news A/V may be immediately after sports news is presented. The selected advertisement object is then inserted into the multimedia object at the determined appropriate position. The system 100 includes an insertion module 130 to insert the advertisement object to the determined position. In various embodiments of the invention, the insertion module 130 may transform the advertisement object prior to insertion in the multimedia object. Such a transform is intended to improve the presentation of the inserted advertisement object in the multimedia object. The transform may include, without limitation, normalizing volume differences between the advertisement object and multimedia object, render text from the advertising for insertion into the video stream, equalizing file types (e.g. wma, mp3, AAC, etc.) of advertisement object and multimedia object, normalizing different bit-rates across advertisement object and multimedia object.

In an operational example, multimedia source 105[1] provides a multimedia object, OBJECT1, to the system 100. The context identifier 115 identifies context information of one or more portions of OBJECT1, and provides the identified context information to the advertisement selection module 120. The context identifier module 115 further provides the position of the context information in the multimedia object hereinafter referred to as ‘context position’. The advertisement selection module 120 selects the advertisement object most closely matching the context information of the portion of the OBJECT1. The position identifier module 125 determines an appropriate position within OBJECT1 to insert the selected advertisement object. The insertion module then inserts the advertisement object into OBJECT1 at the appropriate position.

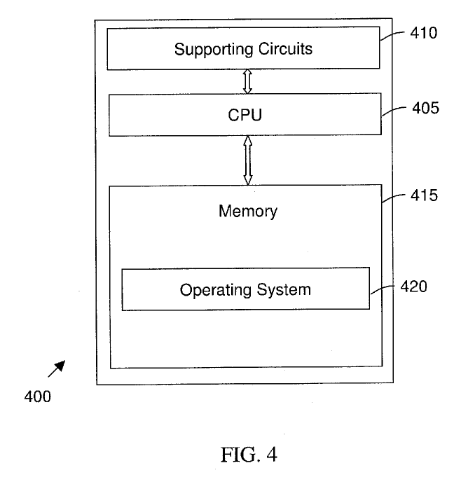

The context identifier module 115, the advertisement selection module 120, the position identifier module 125, and the insertion module 130 reside in the memory of one or more data processing devices. Those skilled in the art will appreciate that various forms of data processing devices may be employed in various embodiments the present invention including, without limitation, personal computers, servers, mainframes, and the like. An exemplary embodiment of a data processing device is described in detail with reference to FIG. 4 below.

As a business model of the present invention, the above system may be implemented in various ways. One of the ways is by using the above system as a service based model using various service providers. The service provider is defined as entity that can perform the task of one or more of creating, maintaining, supporting, and the like of a computer infrastructure that performs one or more process steps of the invention for customers. In return, the service provider can receive payment from the customer(s) under some predetermined criteria, such as a subscription, fee agreement, or the like. In one embodiment of the invention, a service provider may process the multimedia object to identify context information and an appropriate position for insertion of the advertisement object into the multimedia object, search one or more advertisement objects for an advertisement object having a context relevant to the identified context information of the multimedia object, and insert the advertisement object into the multimedia object at the appropriate position. The service provider may further select the advertising object based on criteria selected from a group consisting of demographics, geography, user behavior, business rules and agreements. Companies or individuals interested in availing their service may opt for any one or all of the above.

In another embodiment of the invention various service providers may come together to provide the services provided by the various modules of the present invention. For example, a first service provider may specifically process the multimedia object to identify context information and an appropriate position for insertion of the advertisement object in each of the multimedia object. A second service provider may specifically search one or more advertisement objects for an advertisement object having a context relevant to the identified context information of the multimedia object. The second service provider may further select the advertising object based on criteria selected from a group consisting of demographics, geography, behavior, business rules and agreements. A third service provider may specifically insert the advertisement object in the multimedia object at the appropriate position. In one embodiment of the invention, the first service provider and the second service provider are one entity. In another embodiment of the invention, the second service provider and the third service provider may be a single entity.

In various embodiments of the invention, the service provider may charge an additional advertising fee to an advertiser when the context of the advertisement object matches closely with the context information extracted from the multimedia object. The advertiser may be a company or individual benefiting by the advertisement object. In one embodiment of the invention, the service provider may grade the relevance of the advertisement object with the context information on a varying scale. The service provider may charge an additional advertising fee to an advertiser based on the relevance scale determined for the advertisement object.

FIG. 2 is a block diagram illustrating an exemplary context identifier module 115. In accordance with an exemplary embodiment of the invention, the context identifier module 115 includes a first text converter 205 for extracting textual data from the multimedia object provided by a source. In one embodiment of the invention, the first text converter includes a speech recognition engine to convert the multimedia object into the textual data. The speech recognition engine uses an algorithm implemented as a computer program to convert a speech signal to sequence of words.

In one embodiment of the invention, the first text converter 205 disregards lower confidence word results from the textual data. Usually the speech recognition engine determines a confidence value for each translated word/phrase/sentence. The words having lower confidence value have higher probability of incorrectly identified. In various embodiments of the invention, the words with the confidence value below a cutoff are defined as lower confidence words.

In various embodiments of the invention, the first text converter 205 disregards stop word results from the textual data. The stop words may be the general English words used to complete the structure of a sentence. Examples of the stop words include, without limitation, ‘a’, ‘to’, ‘and’, and ‘the’.

The first text converter 205 may further include a domain specific vocabulary engine, comprising a set of words, terms, and codes specific to a domain. For example, a domain specific vocabulary for the food industry comprises words, phrases, terminologies specific to the industry. When a particular set of extracted keywords represents multiple meanings at a time, the domain specific vocabulary may distinctly identify the word relevant to a specific domain. In one embodiment of the invention, the domain specific vocabulary may be dynamically updated to as per the word usage patterns in the domain. In one embodiment of the invention, the domain specific vocabulary may be updated using text from standard web pages of the domain. For example, to create a sports specific vocabulary a sports website may be used. In one embodiment of the invention, the speech recognition engine is based on the Hidden Markov Model. Those skilled in the art will appreciate that various models of the speech recognition engine may be employed in various embodiments of the present invention including, without limitation, Hidden Markov Model based speech recognition, Neural Network-based speech recognition, Dynamic Time-wrapping based speech recognition, Knowledge based speech recognition, and the like.

In one embodiment of the invention, the first text converter comprises an Optical-Character Recognition (OCR). The OCR is used to translate images of handwritten or typewritten text into machine-editable text.

The context identifier module 115 includes a keyword-extracting module 210 to extract keywords and keyword locations from the textual data. The location of the keyword in the textual data may be used to determine location of the context information in the multimedia object.

The context identifier module 115 further includes a segment identifying module 215, and a context-building module 220. The segment identifying module 215 identifies at least one segment in the textual data. The segment may comprise a sub-set of extracted keywords along with the position of the extracted keywords in the multimedia object. The context-building module 220 determines the context information for the segment using the corresponding sub-set of keywords. In various embodiments of the invention, the context-building module may abstract or derive context information for the segment based on the sub-set of keywords. Various embodiments of the invention advantageously allow the system to select an advertisement object which is not associated with any specific extracted keyword. For example, the sub-set of keywords may mention words like “tiger wood”, “champion”, “open”, “masters”, etc., that are related to context information “Golf”. In such an example, the context-building module may determine the context information of the segment as “Golf”. In one embodiment of the invention, the segment identifying module 215 may identify a continuous segment related to particular context information based on the context information.

In various embodiments of the invention, the keyword-extracting module may further augment additional keywords to determine the context information. In one embodiment of the invention, the keyword-extracting module 210 may augment the additional keywords from metadata information associated with the multimedia object. Metadata information includes, without limitation, text contents associated with the multimedia object (e.g. title text, description text), Rich Site Summary (RSS) feed associated to the multimedia object, and tags provided by the source. In one embodiment of the invention, the keyword-extracting module 210 may further augment the additional keywords from the content on the webpage hosting the multimedia object. In one embodiment of the invention, the keyword-extracting module 210 may further augment the additional keywords from the content on the webpage in the domain of the multimedia object. The context-building module 220 may then correlate the addition keywords with the keywords extracted by the first text converter.

FIG. 3 is a block diagram illustrating an exemplary advertisement selection module 120. In accordance with an embodiment of the invention, the advertisement selection module 120 includes a second text converter 305 for extracting textual advertisement data from the advertisement object provided by an advertisement source. The second text converter includes a speech recognition engine to convert the advertisement object into textual data to facilitate the extraction. The second text converter 305 may further include a domain specific vocabulary engine. The advertisement selection module 120 further includes a matching engine 310 for matching multimedia object context information with the textual advertising data. In various embodiments of the invention, the matching engine may use keywords related to the context information. Those skilled in the art will appreciate that various text-matching techniques may be employed in various embodiments the present invention including, but not limited to, Term Frequency Inverse Document Frequency, Naïve Bayesian, Neural Networks, Support Vector Machine, and other informational retrieval and machine learning techniques.

In one embodiment of the invention, the second text converter comprises an Optical-Character Recognition (OCR). The OCR is used to translate images of handwritten or typewritten text into machine-editable text.

FIG. 4 is a block diagram of an exemplary data processing device 400 suitable for implementing various embodiments of the present invention. The data processing device 400 includes at least one central processing unit (CPU) 405, support circuits 410, and memory 415. The CPU 405 comprises at least one microprocessor or microcontroller. The support circuits 410 are well-known circuits that support the operation of the CPU 405 including but not limited to, power supplies, clocks, cache, input/output circuits, network cards, and the like. Memory 415 may include dynamic or static random access memory, magnetic or optical data storage disks, or magnetic data storage tapes, and the like. Other processing and memory means, including various computer readable media, may be used for storing and executing program instructions. The memory 415 comprises an operating system (OS) 420, a context identifier module 115, an advertisement selection module 120, a position identifier module 125, and an insertion module 130. The OS 420 and other software may comprise various executable application modules. The teachings of the present invention may be embodied in the form of computer readable program code that is executable on the data processing device 400.

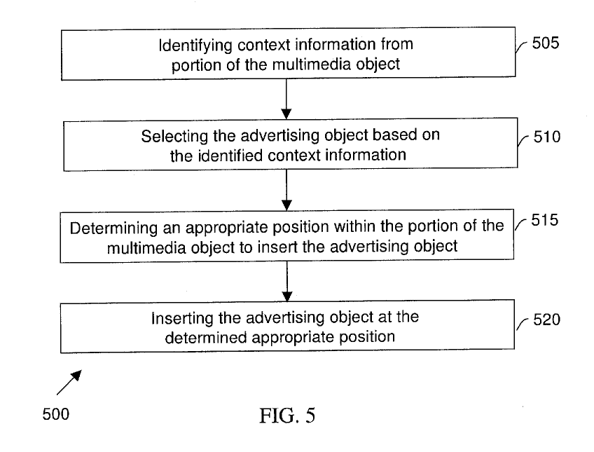

FIG. 5 is a flow diagram representation of a method 500 for inserting a contextually relevant advertisement object into a multimedia object, in accordance with an embodiment of the present invention. At step 505, the context identifier module identifies multimedia object context information. The context identifier module may identify different context information for one or more portions of the multimedia object. At step 510, the advertisement selection module selects an advertisement object based on the identified context information. The advertisement module may select different advertisement objects for different portions of the multimedia object. For example, if the context information of a first and second portion of the multimedia object may be related to sports and music respectively, then the advertisement selection module may select an advertisement object related to sports for the first portion, and an advertisement object related to music for the second portion of the multimedia object.

Continuing with step 515, the position identifier module determines an appropriate position within the portion of the multimedia object to insert the advertisement object. At step 520, the insertion module inserts the advertisement object into the multimedia object at the determined position. In one embodiment of the invention, the insertion module transforms the advertisement object before inserting it into the multimedia object. For example, if the advertisement object and multimedia object are in different file formats, the insertion module may equalize the format of advertisement object with the format of the multimedia object before the insertion. Other types of transformations are also relevant, such as matching audio volume or tone, video color or tinting, or other factors.

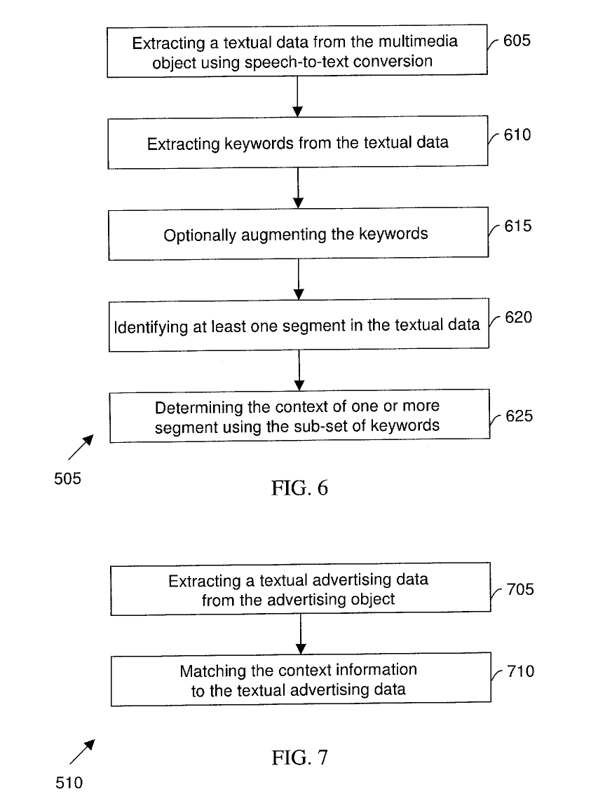

FIG. 6 illustrates exemplary sub-steps of identifying the context information of the multimedia object (step 505). According to an embodiment of the present invention, at step 605, the first speech-to-text converter extracts textual data from the multimedia object using the speech recognition engine. At step 610, the keyword-extracting module then extracts keywords from the textual data. The keyword-extracting module further extracts the location of the extracted keywords in the multimedia object. At step 615, the keyword-extracting module may augment additional keywords to build context information. In one embodiment of the invention, the keyword-extracting module augments the additional keywords from metadata information associated with the multimedia object. In another embodiment of the invention, the keyword-extracting module augments additional keywords from a web page hosting the multimedia object. The keyword-extracting module may correlate the augmented additional keywords with extracted keywords from speech to text conversion.

At step 620, the segment identifier module identifies at least one segment in the textual data. The segment comprises a sub-set of keywords along with the corresponding position in the multimedia object. At step 625, the context building module determines and builds context of the segment. The context building module uses a sub-set of keywords to build the context for the segment.

FIG. 7 illustrates exemplary sub-steps for selecting the advertisement object (step 510). In accordance with an embodiment of the invention, at step 705, the second speech-to-text converter extracts textual advertising data from an advertisement object provided by an advertisement source. The second speech-to-text converter may use a speech recognition engine to extract the textual advertisement data from the advertisement object. AT step 710, the matching engine matches the context information of a multimedia object with the textual advertisement data. In various embodiments of the invention, the matching engine may use keywords related to the context information. In one embodiment of the invention, selecting the advertisement object further comprises selecting the advertising object based on criteria selected from a group consisting of demographics, business rules and agreements.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is understood that various omissions, substitutions of equivalents are contemplated as circumstance may suggest or render expedient, but is intended to cover the application or implementation without departing from the spirit or scope of the claims of the present invention.

While the foregoing is directed to embodiments of the present invention, other and further embodiments of the invention may be devised without departing from the basic scope thereof, and the scope thereof is determined by the claims that follow.

1. A method for inserting a contextually relevant advertisement object into a multimedia object, the method comprising:
identifying context information from a portion of the multimedia object;
selecting the advertisement object based on the identified context information;
determining a position within the portion of the multimedia object to insert the advertisement object; and
inserting the advertisement object into the multimedia object at the determined position.

2. The method of claim 1, wherein the multimedia object includes an audio object, and an audio-video object.

3. The method of claim 1, wherein identifying the context information comprises:
extracting textual data from the multimedia object;
extracting keywords from the textual data along with a corresponding position in the multimedia object;
identifying at least one segment in the textual data, each segment comprising a sub-set of keywords; and
determining the context of one or more segments using the sub-set of keywords.

4. The method of claim 3, wherein extracting the textual data includes one of speech-to-text conversion, and Optical-Character Recognition (OCR).

5. The method of claim 1, wherein identifying the context information comprises extracting keywords from a web page hosting the multimedia object.

6. The method of claim 1, wherein identifying the context information comprises extracting keywords from a web page related to a domain of the multimedia object.

7. The method of claim 1, wherein identifying the context information comprises extracting keywords from metadata information of the multimedia object.

8. The method of claim 3, wherein extracting the textual data comprises using a domain specific vocabulary.

9. The method of claim 1, wherein identifying the context information comprises:
correlating extracted keywords from a source, the source including speech to text conversion, a web page hosting the multimedia object, a web page related to a domain of the multimedia object and metadata of the multimedia object.

10. The method of claim 1, wherein selecting the advertisement object comprises:
extracting textual advertising data from the advertisement; and
matching the context information to the textual advertising data.

11. The method of claim 10, wherein extracting the textual advertising data includes one of speech-to-text conversion, and Optical-Character Recognition (OCR).

12. The method of claim 1, wherein inserting the advertisement object comprises transforming the advertisement object.

13. The method of claim 1, wherein the portion of the multimedia object includes a plurality of portions.

14. A system for inserting an advertisement object into a multimedia object, the system comprising:
a context identifier module identifying context information from a portion of the multimedia object;
an advertisement selection module selecting the advertisement object based on the identified context information; and
a position identifier module determining a position within the portion of the multimedia object to insert the advertisement object.

15. The system of claim 14, further comprising an insertion module inserting the advertisement object into the multimedia object at the position.

16. The system of claim 14, wherein the multimedia object includes an audio object, and an audio-video object.

17. The system of claim 14, wherein the context identifier module comprises:
a first text converter extracting textual data from the multimedia object;
a keyword extracting module extracting keywords from the textual data along with a corresponding position in the multimedia object;
a segment identifying module identifying at least one segment in the textual data, each segment comprising a sub-set of keywords; and
a context building module determining the context information of the sub-set of keywords.

18. The system of claim 17, wherein the first text converter includes one of a speech-to-text converter, and an Optical-Character Recognition (OCR) engine.

19. The system of claim 17, wherein the first text converter comprises a domain specific vocabulary engine.

20. The system of claim 17, wherein the advertisement selection module comprises:
a second text converter extracting textual advertising data from the advertisement object; and
a matching engine matching the context information to the textual advertising data.

21. A computer readable medium comprising a program that, when executed by a processor, performs a method for inserting a contextually relevant advertisement object into a multimedia object, the program comprising:
a computer readable program for identifying context information from a portion of the multimedia object;
a computer readable program for selecting the advertisement object based on the identified context information; and
a computer readable program for determining a position within the portion of the multimedia object to insert the advertisement object.

22. The computer readable medium of claim 21, comprising a computer readable program for inserting the advertisement object into the multimedia object at the determined position.

23. The computer readable medium of claim 21, wherein computer readable program for identifying the context information comprises:
a computer readable program for extracting textual data from the multimedia object;
a computer readable program for extracting keywords from the textual data along with the corresponding position in the multimedia object;
a computer readable program for identifying at least one segment in the textual data, each segment comprising a sub-set of keywords; and
a computer readable program for determining the context of the sub-set of keywords in one or more segment.

24. The computer readable medium of claim 21, wherein identifying the context information comprises a computer readable program for extracting keywords from a web page hosting the multimedia object.

25. The computer readable medium of claim 21, wherein computer readable program for identifying the context information comprises a computer readable program for extracting keywords from metadata information from the multimedia object.

26. The computer readable medium of claim 23, wherein computer readable program for identifying the context information comprises:
a computer readable program for correlating the extracted keywords from a source, the source including speech to text conversion, a web page hosting the multimedia object, a web page related to a domain of the multimedia object and metadata of the multimedia object.

27. The computer readable medium of claim 21, wherein computer readable program for selecting the advertisement object comprises:
a computer readable program for extracting textual advertising data from the advertisement object; and
a computer readable program for matching the context information to the textual advertising data.

28. The computer readable medium of claim 22, wherein the computer readable program for inserting the advertisement object comprises a computer readable program for transforming the advertisement object.

29. A method for inserting one of one or more advertisement objects into a multimedia object, the method comprising:
processing the multimedia object to identify context information and a position for insertion of an advertisement object into the multimedia object;
searching the one or more advertisement objects for an advertisement object having a context relevant to the identified context information of the multimedia object; and
inserting the advertisement object in the multimedia object at the appropriate position.

30. The method of claim 29, wherein searching the advertisement source further comprises selecting the advertising object based on criteria selected from a group consisting of demographics, business rules and agreements.

31. The method of claim 29, further comprising charging an advertiser an additional advertising fee when context of the advertisement object matches with the context information.
